(19) United States
(12) Patent Application Publication
(10) Pub. No.: US 2021/0375269 A1
(43) Pub. Date: Dec. 2, 2021

(54) SYSTEMS AND METHODS FOR DOMAIN ADAPTATION IN DIALOG ACT TAGGING

(71) Applicant: salesforce.com, inc., San Francisco, CA (US)

(72) Inventors: Semih Yavuz, Redwood City, CA (US); Kazuma Hashimoto, Menlo Park, CA (US); Wenhao Liu, Redwood City, CA (US); Nitish Shirish Keskar, San Francisco, CA (US); Richard Socher, Menlo Park, CA (US); Caiming Xiong, Menlo Park, CA (US)

(21) Appl. No.: 16/999,426

(22) Filed: Aug. 21, 2020

Related U.S. Application Data
(60) Provisional application No. 63/033,108, filed on Jun. 1, 2020.

(51) Int. Cl. G10L 15/183; G06N 20/00; G10L 15/06; G06F 17/18

(52) U.S. Cl. CPC G10L 15/183; G06F 17/18; G10L 15/063; G06N 20/00

(57) ABSTRACT

Embodiments described herein utilize pre-trained masked language models as the backbone for dialogue act tagging and provide cross-domain generalization of the resulting dialogue acting taggers. For example, a pre-trained MASK token of BERT model may be used as a controllable mechanism for augmenting text input, e.g., generating tags for an input of unlabeled dialogue history. The pre-trained MASK model can be trained with semi-supervised learning, e.g., using multiple objectives from supervised tagging loss, masked tagging loss, masked language model loss, and/or a disagreement loss.

### CROSS-REFERENCES

The present disclosure is a non-provisional of and claims priority under 35 U.S.C. 119 to U.S. provisional application No. 63/033,108, filed on Jun. 1, 2020, which is hereby expressly incorporated by reference herein in its entirety.

### TECHNICAL FIELD

The present disclosure relates generally to machine learning models and neural networks, and more specifically, to dialogue act tagging with pre-trained mask tokens.

### BACKGROUND

Neural networks have been used to generate conversational responses and thus conduct a dialogue with a human user. Specifically, a task-oriented dialogue system can be used to understand user requests, ask for clarification, provide related information, and take actions. Dialog act tagging utilizes a neural model to capture the speaker's intention behind the utterances at each dialog turn, such as “request,” “inform,” “system offer,” etc. Acquiring annotated labels in dialogue data for task-oriented dialogue systems can often be expensive and time-consuming. In addition, dialogues with the task-oriented system may occur in different domains, such as restaurant reservations, finding places of interest, booking flights, navigation or driving directions, etc. A dialogue act tagger trained on one domain such as restaurant reservations may not generalize well to serve dialogues in other domains, such as booking flights, navigation or driving directions, etc., which further increases the burden for a large amount of annotated data in the target domain for training the dialogue act tagger.

Therefore, there is a need for an efficient dialogue act tagger for task-oriented dialogues.

### BRIEF DESCRIPTION OF THE DRAWINGS

FIG. 1 provides an example block diagram illustrating an aspect of using a pre-trained language model for dialogue act tagging tasks, according to one embodiment described herein.

FIGS. 2A-2B provide example data segments of the labeled dialogues in the source domain of restaurant reservation and target domain of flight booking, respectively, according to one example of the embodiment.

FIG. 3 is a simplified diagram of a computing device for implementing a neural network for dialogue act tagging with a pre-trained mask model, according to some embodiments.

FIGS. 4A-4D provide example block diagrams illustrating training mechanisms executed by each of the submodules shown in FIG. 3, according to one embodiments described herein.

FIG. 5 provides a block diagram illustrating an example of mask augmentation of an input sequence under the teacher-student mechanism shown in FIG. 4D, according to embodiments described herein.

FIG. 6 is a simplified logic flow diagram illustrating a method for training a language model based dialogue act tagging module, according to some embodiments.

FIG. 7 is a simplified logic flow diagram illustrating a method for teacher-student training with a disagreement loss as described in FIG. 4D, according to one embodiment described herein.

FIG. 8 provides a data table illustrating example performance of adapting the dialogue act tagger from source domain to a target domain, according to one example of the embodiment.

FIG. 9 provides an example data table showing the micro-F1 scores on target domain for pre-BERT (obtained by domain-adaptive pre-training) in comparison with scratch-BERT (initialized from BERT) across different fine-tuning objectives, according to one example of the embodiment.

FIG. 10 shows a data table illustrating example F1 scores on target domain under the low-resource setting, according to one example of the embodiment.

FIG. 11 shows a data table illustrating F1 scores on source and target domains when the masked language model objective on unlabeled target domain examples is incorporated into the training, according to one example of the embodiment.

FIG. 12 shows a data table illustrating micro-F1 scores for each dialog act on the test split of target domain, according to one example of the embodiment.

FIGS. 13A-13C provide example data outputs of dialogue act tags from the language model, according to one example of the embodiment described herein.

In the figures and appendix, elements having the same designations have the same or similar functions.

### DETAILED DESCRIPTION

Acquiring annotated labels in dialogue data for task-oriented dialogue systems can often be expensive and time-consuming. While it is often challenging and costly to obtain a large amount of in-domain dialogues with annotations, unlabeled dialogue corpora in target domain may be curated from past conversation logs or collected via crowd-sourcing at a more reasonable effort. For example, the act of “request” carries the same speaker intention whether it is for restaurant reservation or flight booking. However, dialogue act taggers trained on one domain do not generalize well to other domains, leading to an expensive need for a large amount of annotated data in the target domain.

Some existing dialogue act taggers adopt a universal schema for dialogue taggers by aligning annotations for multiple existing corpora. For example, the Schema-guided dialogues (SGD) introduced in Rastogi et al., Towards scalable multi-domain conversational agents: the schema-guided dialogue dataset, arXiv preprint arXiv: 1909.05855, 2019, which is hereby expressly incorporated by reference herein in its entirety. The SGD covers 20 domains under the same dialogue act tagging annotation schema. However, this universal tagging scheme is limited to a few domains and thus lacks scalability.

Thus, in view of the need for efficient dialogue act tagging, embodiments described herein utilize a pre-trained masked language model as the backbone for dialogue act tagging and provide cross-domain generalization of the resulting dialogue acting taggers. For example, a pre-trained MASK token of BERT model may be used as a controllable mechanism that stochastically augments text input by randomly replacing the input tokens with a mask token, e.g., “MASK.” A consistency regularization approach is adopted to provide an unsupervised teacher-student learning scheme by leveraging the pre-trained language model for generating teacher and student representations retaining different amount of the original content from the unlabeled dialogue example.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

### Overview

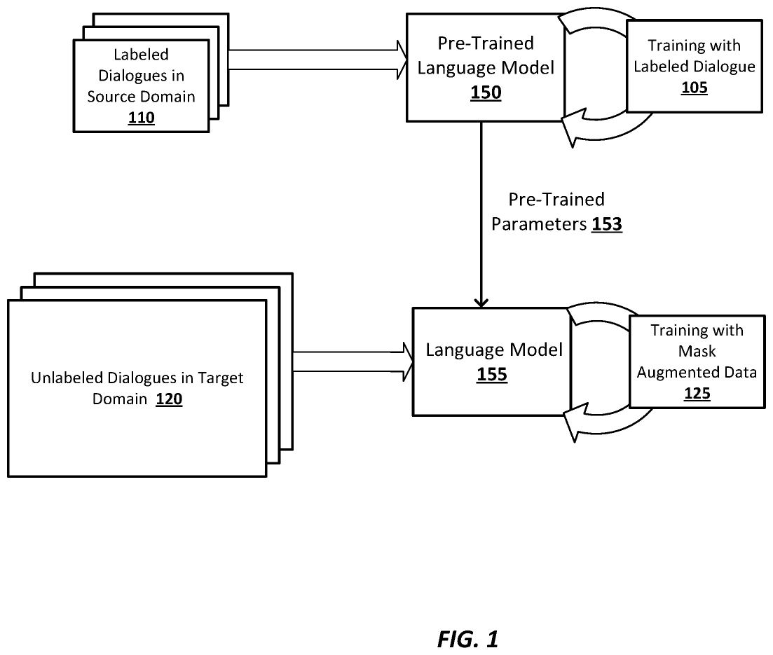

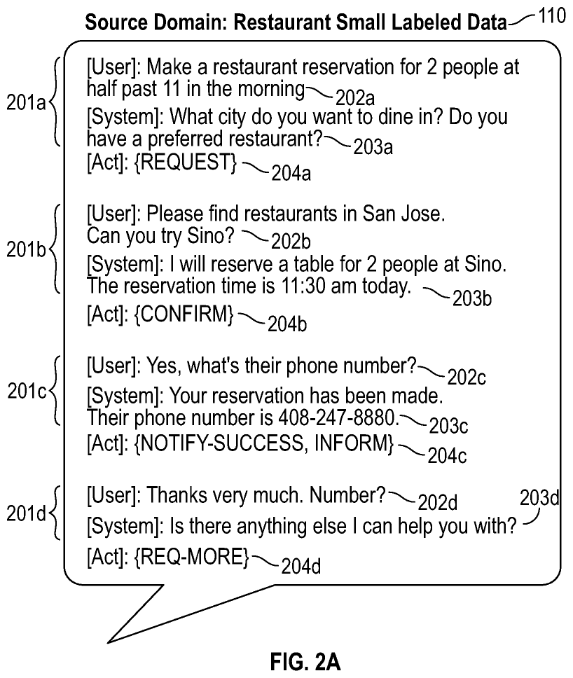

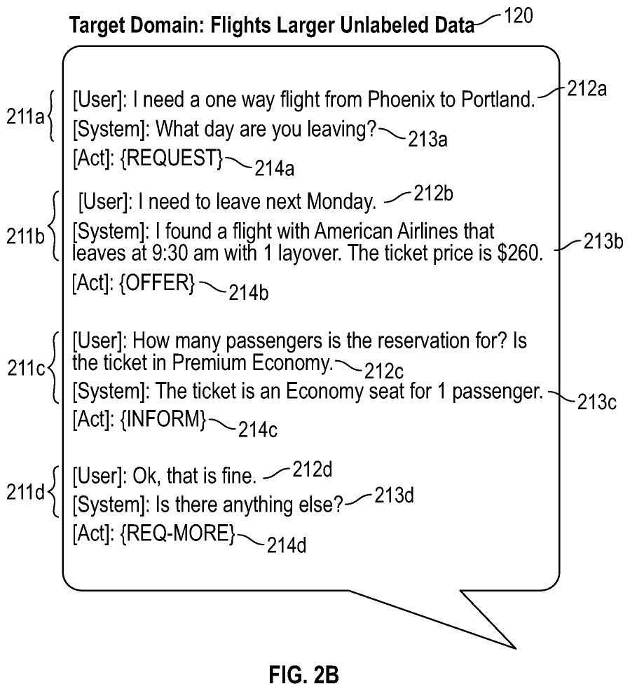

FIG. 1 provides an example block diagram illustrating an aspect of using a pre-trained language model for dialogue act tagging tasks, according to one embodiment described herein. Dialogue tagging may be processed as a multi-label classification problem. For example, a language model 150, such as the bidirectional encoder representation transformer (BERT), may be used for dialogue act tagging. The language model 150 may be trained with labeled dialogues in a source domain 110 (e.g., a source domain of restaurant reservation), e.g., as shown at 105. FIG. 2A provides an example data segment of the labeled dialogue 110 in the source domain of restaurant reservation. The labeled dialogue 110 in the source domain may include multiple dialogue turns 201a-d. Each dialogue turn 201a-d includes a user utterance 202a-d and a system response 203a-d, which may be annotated with a label indicating the intention associated with the dialogue turn, such as “Request” 204a, “Confirm” 204b, “Notify-Success” 204c, “req-more” 204d, and/or the like.

Although the language model 150 has been pre-trained with the labeled dialogue at 105 in the source domain, the language model 155 with the pre-trained parameters 153 may not be readily capable of performing dialogue act tagging for dialogues in a different domain, e.g., a target domain in booking flights. For example, FIG. 2B provides an example data segment of the dialogue data 120 in the target domain of flight bookings. The dialogue 120 in the target domain includes a plurality of dialogue turns 211a-d, each of which includes a user utterance 212a-d and a system response 213a-d. Although each dialogue turn 211a-d in the dialogue 120 may be associated with a dialogue turn tag such as “Request” 214a, “Offer” 214b, “Inform” 214c, “req-more” 214d, and/or the like, which may be roughly similar to the tags 204a-d of dialogue 110, the specific contents of the utterances of dialogues 110 and 120 can be rather distinct due to the domain difference, thus making the cross-domain generalization challenging. In other words, the language model 150 pre-trained with labeled dialogue data 110 may not be readily applicable to provide accurate tagging for unlabeled dialogue data 120 in a different domain.

To adapt the pre-trained language model 150 to the target domain, embodiments described herein utilizes the pre-trained language model 150 with the pre-trained parameters 153 to implement mask augmentation of the unlabeled dialogue data in the target domain 120. Specifically, text input from the unlabeled dialogues in the target domain 120 are stochastically augmented by randomly replacing the tokens of the text input with a MASK token, e.g., “[MASK].” The language model 155 (loaded with pre-trained parameters 153 from pre-trained language model 150) is then trained with the mask augmented data, e.g., at 125.

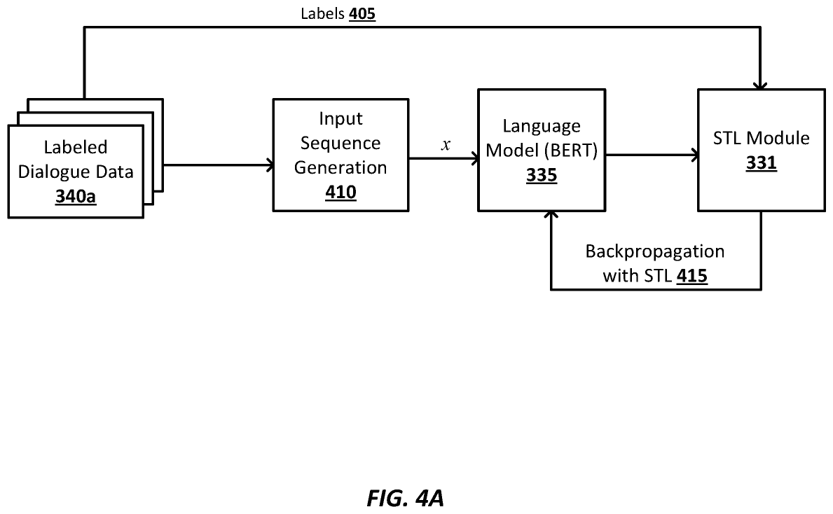

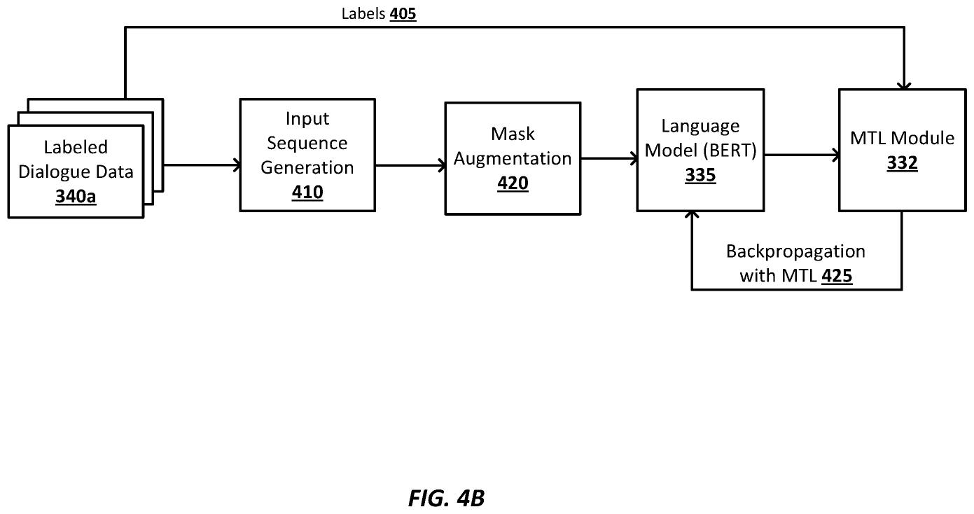

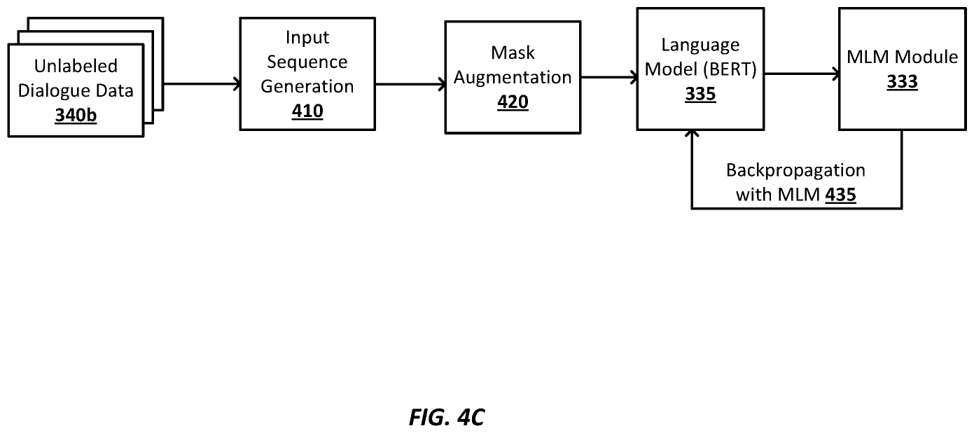

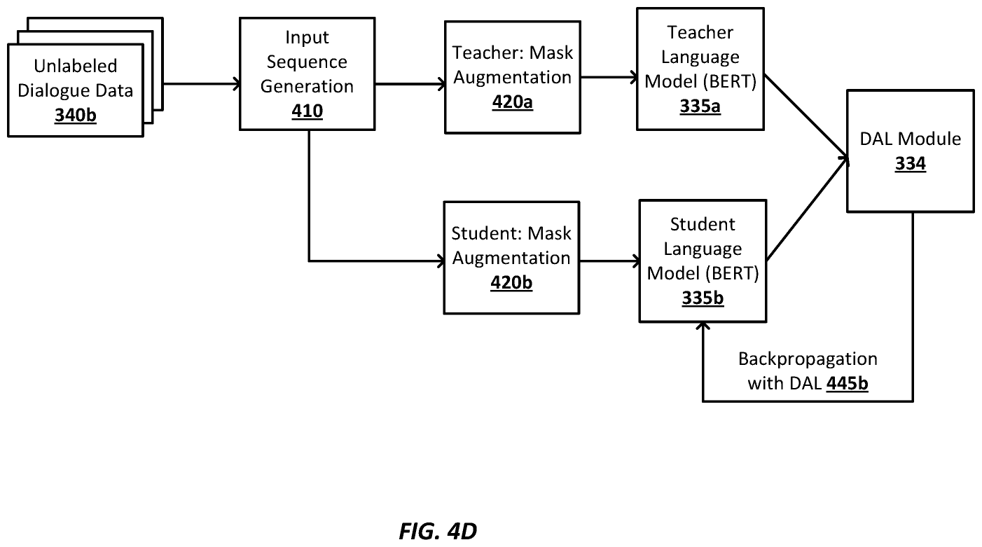

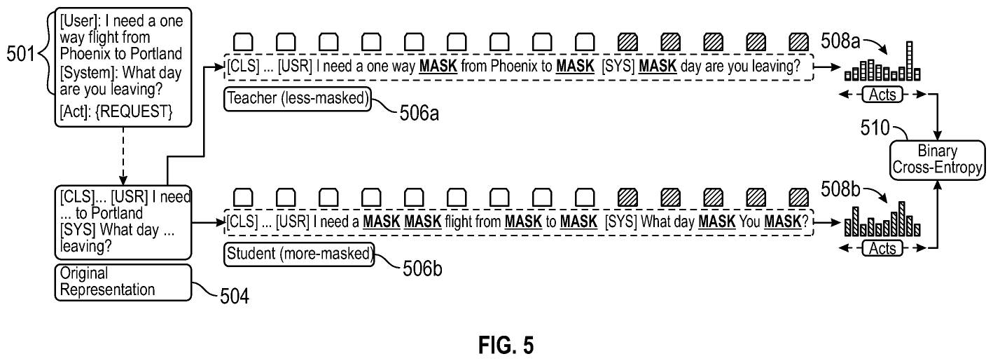

For example, the training with mask augmented data 125 may include various supervised, semi-supervised, or unsupervised fine-tuning objectives. Specifically, an unsupervised teacher-student learning scheme may be implemented by leveraging mask augmented data for generating teacher and student representations retaining different amount of the original content from the unlabeled dialogue 120. The teacher-student scheme is further illustrated in FIGS. 4D-5.

In this way, by training the language model 155 with mask augmented data from the unlabeled dialogue in the target domain 120, the language model 155 (pre-trained with labeled dialogues in the source domain 110) may be adapted to performing dialogue act tagging tasks in the target domain, without learning through a large amount of labeled dialogues in the target domain.

Computer Environment

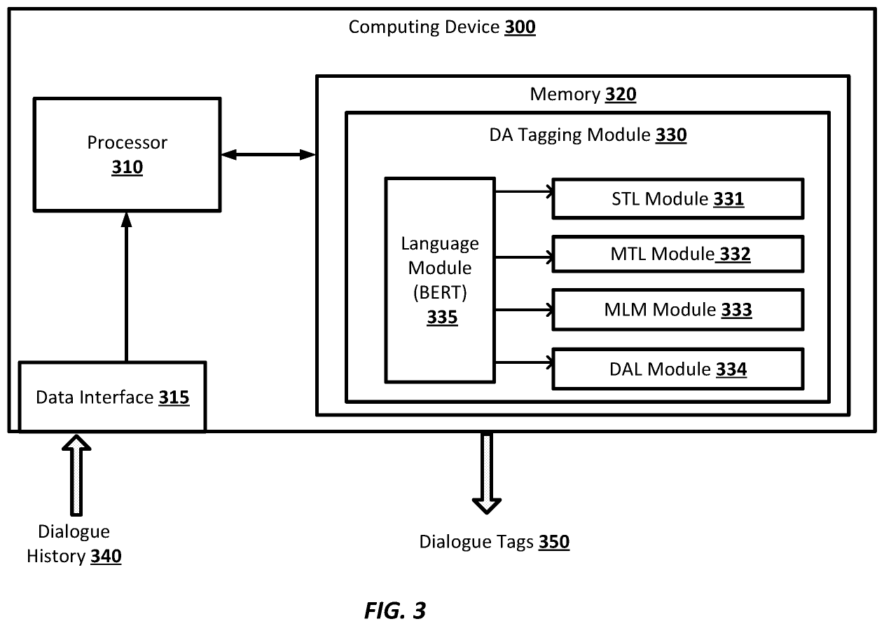

FIG. 3 is a simplified diagram of a computing device for implementing a neural network for dialogue act tagging with a pre-trained mask model, according to some embodiments. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for a dialogue act tagging module 330 that may be used to implement and/or emulate the systems and models, and/or to implement any of the methods described further herein. In some examples, the dialogue tagging module 330 may be used to receive and handle the input of a dialogue history 340 and generate an output of dialogue tags 350. In some embodiments, the output 350 of dialogue tags may appear in the form of classification distributions of different tags. In some examples, the dialogue act tagging module 330 may also handle the iterative training and/or evaluation of a system or model used for dialogue act tagging.

In some embodiments, the dialogue act tagging module 330 includes a supervised tagging loss (STL) module 331, a masked tagging loss (MTL) module 332, a masked language model loss (MLM) module 333, a disagreement loss module 334, and a language module 335. The modules and/or submodules 331-335 may be serially connected or connected in other manners. For example, the language module 335 may be a pre-trained MASK token language model, such as but not limited to BERT, etc., which may be trained by one or more of the modules 331-334.

For example, the STL module 331 is configured to update the language module 335 using a supervised objective from a labeled source dataset. For another example, the MTL module 332 is configured to incorporate MASK tokens into the STL training. The MTL module 332 may perturb the input dialogue history 340 by replacing randomly selected tokens with a specified probability with MASK tokens. For another example, the MLM module 333 may train the language module 335 with the original objective that the language module 335 has been pre-trained with. The objective of MLM training is to correctly reconstruct a randomly selected subset of input tokens leveraging the unmasked context. For another example, the DAL module 334 utilizes an unsupervised teacher-student training mechanism to control the level and kind of discrete perturbations to achieve augmentation of the text input 340. Training mechanisms executed by each of the submodules 331-334 may be further illustrated in FIGS. 4A-4D.

In some examples, the dialogue act tagging module 330 and the sub-modules 331-335 may be implemented using hardware, software, and/or a combination of hardware and software.

Dialogue Act Tagging with Mask Augmentation

FIGS. 4A-4D provide example block diagrams illustrating training mechanisms executed by each of the submodules 331-334 shown in FIG. 3, according to one embodiments described herein. Specifically, the dialogue tagging task may be formalized as a multi-label classification problem. The dialogue of n turns may be denoted as D=[T₁, T₂, . . . , Tₙ] as a series of user and system utterances. The objective of dialogue act tagging is to determine a subset Aₖ ⊆A of dialogue acts that apply to the current turn Tₖ given the conversation history Dₖ=[T₁, T₂, . . . , Tₖ] so far. This objective may then be formulated as a classification problem with binary labels yⱼ ∈{0, 1} for each act aⱼ where yⱼ=1 if aⱼ ∈Aₖ and yⱼ=0 otherwise. As defined above, dialogue act tagging is a turn-level classification problem, hence every turn Tₖ constitutes: (i) a labeled example (D_{:k}, Aₖ) if a set Aₖ of dialogue act annotations are available, or (ii) an unlabeled example (D_{:k}, •) otherwise.

FIG. 4A shows aspects of learning a supervised objective such as the supervised tagging loss (STL). As shown in FIG. 4A, if at least part of the input dialogue history 340 is labeled, e.g., as labeled dialogue data 340a, represented by (D_{:k}, Aₖ), the labeled data 340a may be converted into a sequence of words by concatenating user and system utterances at the input sequence generation module 410. Before concatenating each utterance, the sequence of words is prepended with corresponding speaker tag using [SYS] and [USR] special tokens indicating system and user sides, respectively. Finally, the whole flattened sequence is finalized by prepending it with [CLS] special token to obtain the final dialogue history representation: x=[CLS] . . . [USR] Tᵢ [SYS] Tᵢ₊₁ . . . . The segment IDs are set to 0 and 1 for the tokens of past turns and the current turn, respectively.

For dialogue act tagging tasks, the representation of dialogue history x is used as an input sequence to a pre-trained language model (e.g., BERT) 335, and the model computes a probability vector p_{θ}(·|x)=σ(WM(x)+b), where M(x) ∈ [symbol] ^{d} is the output contextualized embedding corresponding to CLS token, W ∈ [symbol] ^{m×d} and b ∈ [symbol] ^{m} are trainable weights of a linear projection layer, σ is the sigmoid function, θ denotes the entire set of trainable parameters of model M along with (W, b), and finally p_{θ}(aⱼ|x) indicates the probability of tag aⱼ being triggered. Thus, the output distribution p_{θ}(aⱼ|x) is generated by the language model 335 and output to the supervised tagging loss (STL) module 331.

The STL module 331 is configured to update the language model 335 via the supervision coming from labeled source data 340a. For example, the STL module 331 may obtain the annotated labels 405 (e.g., {yⱼ}) from the labeled dialogue data 340a, and then compare the annotated labels yⱼ with the output distribution p_{θ}(aⱼ|x) from the language model 335. A binary-cross entropy loss [symbol] _{STL}(θ; x, y) can be computed by the STL module as:

−[y log p_{θ}(·|x)+(1−y)·log(1−p_{θ}(·|x))].

The computed [symbol] _{STL}(θ; x, y) may then be used to update the language model 335 via backpropagation 415.

FIG. 4B shows aspects of learning through a semi-supervised objective such as the masked tagging loss (MTL). Semi-supervised learning (SSL) may be an effective approach for improving deep learning models by leveraging in-domain unlabeled data. The MTL objective may be used to address the underlying source-to-target domain. As shown in FIG. 4B, after the input sequence generation module 410, a mask augmentation module 420 is configured to augment the original text input by randomly replacing its tokens with a mask token, e.g., [MASK], at a specified probability. The masking policy may be similar to the mask policy adopted in Devlin et al., BERT: Pre-training of deep bidirectional transformers for language under-standing, in Proceedings of the 2019 Conference of the North American Chapter of the Association for Computational Linguistics: Human Language Technologies, which is hereby expressly incorporated by reference herein in its entirety. Formally, let z(\ddot{x}|x, ∈) denote the mask augmentation at module 420 as a stochastic transformation with ∈-probability for input x. The masked input sequence from the mask augmentation module 420 is then input to the language model 335 to generate the output distribution, similar to FIG. 4A.

Thus, the mask augmentation may be incorporated into the STL objective discussed in relation to FIG. 4A to compute the following MTL by the MTL module with labels 405 from the labeled dialogue data 340a:

[symbol]

_{MTL}(θ;x,y,∈)= [symbol] _{\ddot{x}˜z(\ddot{x}|x,∈)}[ [symbol] _{STL}(θ;\ddot{x},y)].

The computed [symbol] _{MTL}(θ; x, y, ∈) may then be used to update the language model 335 via backpropagation 425.

FIG. 4C shows aspects of learning through the original objective that has been used to pre-train the language model 335, e.g., BERT. For example, as shown in FIG. 4C, the unlabeled dialogue data 340b from the input dialogue history 340 may be processed by the input sequence generation module 410 and the mask augmentation module 420, e.g., in a similar way as described in relation to FIG. 4B. The masked LM (MLM) loss module 333 may then be used to compute an MLM loss [symbol] _{MLM}(θ; x, ∈) that reconstructs a randomly selected subset (with probability ∈) of input tokens leveraging the unmasked context. The computed [symbol] _{MLM}(θ; x, ∈) may then be used to update the language model 335 via backpropagation 435.

FIG. 4D shows aspects of learning a teacher-student mechanism with disagreement loss (DAL). A consistency regularization approach may be used to define disagreement loss, which employs an unsupervised teacher-student training scheme. Specifically, the teacher-student model controls the amount of discrete perturbations to achieve meaningful augmentation of the text input 340b. Similar to FIG. 4C, unlabeled dialogue data 340b may be passed to the input sequence generation 410 to generate a flattened sequence representation of the dialogue data. A stochastic imputation-based teacher and student selection may be implemented by leveraging mask augmentation. For example, the teacher mask augmentation module 420a is configured to sample the input sequence of tokens according to a first probability ∈ₜ and replace the sampled tokens with the mask token, resulting in an augmented teacher input sequence \ddot{x}^{(t)}˜z(\ddot{x}|x,∈ₜ). The student mask augmentation module 420b is configured to sample the input sequence of tokens according to a second probability ∈ₛ and replace the sampled tokens with the mask token, resulting in an augmented student input sequence \ddot{x}^{(s)}˜z(\ddot{x}|x,∈ₛ). The masking probabilities obey ∈ₜ<∈ₛ, providing that the teacher augmentation \ddot{x}^{(t)} retains more of the original content x than the student augmentation \ddot{x}^{(s)}, hence the teacher is more reliable. The augmented sequences \ddot{x}^{(t)} and \ddot{x}^{(s)} are then passed to the teacher language model 335a and student language model 335b, respectively, each generating an output distribution that is passed to the DAL module 334. The DAL module 334 is then configured to compute the DAL loss [symbol] _{DAL}(θ; x, ∈ₜ, ∈ₛ) as the binary cross-entropy loss between the teacher output distribution p_{θ}(·|\ddot{x}^{(t)}) and the student output distribution p_{θ}(·|\ddot{x}^{(s)}), using the teacher output distribution as the soft target:

[symbol]

_{DAL}(θ;x,∈ₜ,∈ₛ)=−[p_{θ}(·|\ddot{x}^{(t)})·log p_{θ}(·|\ddot{x}^{(s)})+(1−p_{θ}(·|\ddot{x}^{(t)}))·log(1−p_{θ}(·|\ddot{x}^{(s)}))].

The computed [symbol] _{DAL}(θ; x, ∈ₜ, ∈ₛ) may then be used to update the student language model 335b via backpropagation 445b, respectively. In this way, student model 335b is updated to minimize the discrepancy between output distributions of the teacher and the student augmentations.

FIG. 5 provides a block diagram illustrating an example of mask augmentation of an input sequence under the teacher-student mechanism shown in FIG. 4D, according to embodiments described herein. For example, the dialogue turn 501 may be flattened to generate a representation 504 in the form of a flattened sequence. The representation 504 may then be randomly masked, according to a lower probability, resulting in a less-masked teacher input sequence 506a, and according to a higher probability, resulting in a more-masked student input sequence 506b. Both sequences 506a and 506b are passed to a teacher model 335a and a student model 335b, respectively, to produce output distribution 508a and 508b, respectively. The teacher output distribution 508a can then be used as soft target to compute the binary cross-entropy 510 with the student output distribution 508b.

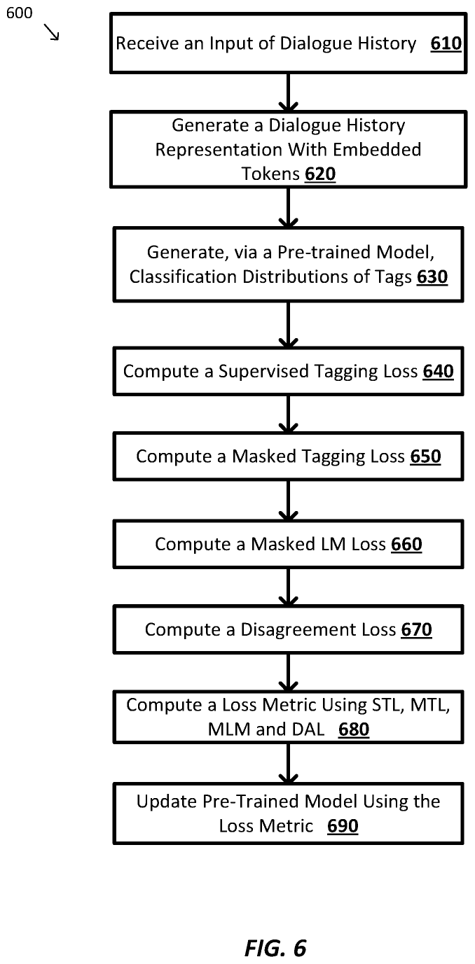

FIG. 6 is a simplified logic flow diagram illustrating a method for training a language model-based dialogue act tagging module, according to some embodiments. One or more of the processes 610-690 of method 600 may be implemented, at least in part, in the form of executable code stored on non-transitory, tangible, machine-readable media that when run by one or more processors may cause the one or more processors to perform one or more of the processes 610-690. In some embodiments, method 600 may correspond to the method used by the dialogue act tagging module 330, and the various training mechanism shown in FIGS. 4A-4D.

At process 610, an input of dialogue history (e.g., 340 in FIG. 3) may be received, via a data interface 315 in FIG. 3. In some embodiments, the input of dialogue history may include labeled data (e.g., 340a shown in FIGS. 4A-4B), and/or unlabeled dialogue data (e.g., 340b shown in FIGS. 4C-4D).

At process 620, a dialogue history representation with embedded tokens may be generated. For example, the dialogue history may be converted into a sequence of words by concatenating user and system utterances in dialogue history. Before concatenating each utterance, the utterance is prepended with corresponding speaker tag using [SYS] and [USR] special tokens indicating system and user sides, respectively. The whole flattened sequence is then finalized by prepending it with [CLS] special token to obtain the final dialogue history representation.

At process 630, a classification distribution of tags is generated using the pre-trained model for the generated input representation from process 620. For example, the representation of the dialogue data is used as the input to the pre-trained language model (e.g., language module 335 in FIG. 3), and the model computes a probability vector indicating a conditional probability of each specific tag, given the input dialogue history.

At process 640, a supervised tagging loss (STL) is computed to train the pre-trained language model. For example, the objective of supervised tagging loss is to update the model via the supervision coming from a labeled source dataset. The binary-cross entropy loss may be computed based on the ground truth labels from the labeled source dataset and the tag distribution from process 630, as described in relation to FIG. 4A.

At process 650, a masked tagging loss (MTL) is computed. Specifically, the original text input (e.g., dialogue history 340) is perturbed by replacing randomly selected tokens with a specified probability with MASK tokens. The masked tagging loss is computed as the expectation of the supervised tagging loss, computed in a similar manner as process 640, resulting from the perturbed input, as described in relation to FIG. 4B.

At process 660, a masked language model loss (MLM) is computed, e.g., using the objective function that masked language models like BERT are pre-trained with. The objective of MLM training is to correctly reconstruct a randomly selected subset of input tokens leveraging the unmasked context, as described in relation to FIG. 4C.

At process 670, a disagreement loss (DAL) can be computed, e.g., via a teacher and student training mechanism. Specifically, the input sequence representing the dialogue history, generated from process 620, may be randomly masked according to a low probability and a high probability. The resulting two input sequences are input to the teacher model and the student model, to result in a teacher output to be used as a soft target and a student output, respectively, which can be used to compute a DAL loss between the teacher and the student, as further described in relation to FIG. 4D.

At process 680, an aggregated loss metric may be computed. In some embodiments, the final loss function is a weighted combination of objectives STL, MTL, MLM, DAL depending on which are activated. For example, the loss terms of the active ones of STL, MTL, DAL are summed and then added with MLM after multiplying it with 0.1 balancing factor when active.

At process 690, the pre-trained model (e.g., the language module 335 in FIG. 3) is updated using the loss metric from process 680. In some implementations, the pre-trained model may be trained separately using any of the individual losses from processes 640-670.

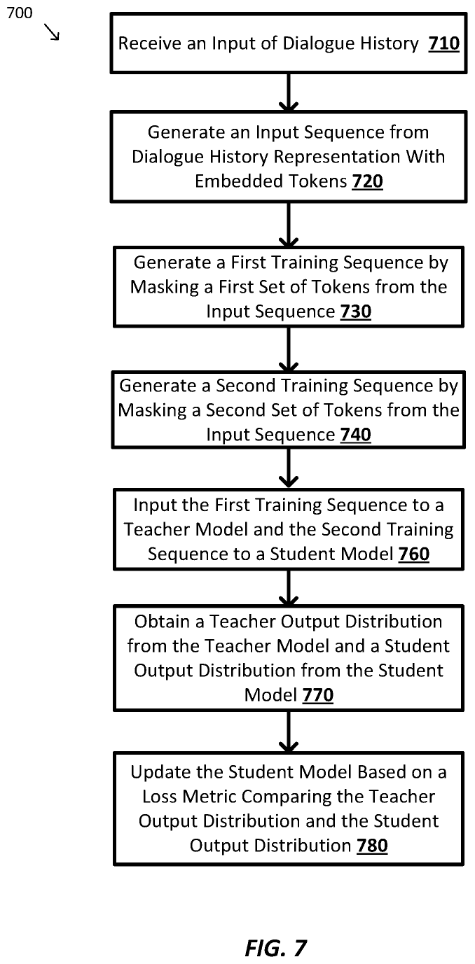

FIG. 7 is a simplified logic flow diagram illustrating a method for teacher-student training with a disagreement loss as described in FIG. 4D, according to one embodiment described herein. One or more of the processes 710-780 of method 700 may be implemented, at least in part, in the form of executable code stored on non-transitory, tangible, machine-readable media that when run by one or more processors may cause the one or more processors to perform one or more of the processes 710-780. In some embodiments, method 700 may correspond to the method used by the dialogue act tagging module 330, and the teacher-student training mechanism shown in FIG. 4D.

At process 710, an input of dialogue history (e.g., 340 in FIG. 3) may be received, via a data interface 315 in FIG. 3. In some embodiments, the input of dialogue history may include unlabeled dialogue data (e.g., 340b shown in FIG. 4D).

At process 720, a dialogue history representation with embedded tokens may be generated, e.g., similar to process 620.

At process 730, a first training sequence may be generated by masking a first set of tokens from an input sequence obtained from the dialogue history. For example, as shown in FIG. 5, a less-masked input sequence 506a is generated from the original representation 504.

At process 740, a second training sequence may be generated by masking a second set of tokens from the input sequence. For example, as shown in FIG. 5, a more-masked input sequence 506b is generated from the original representation 504.

At process 760, the first training sequence is input to the teacher model (e.g., module 335a in FIG. 4D) and the second training sequence is input to the student model (e.g., module 335b in FIG. 4D), respectively.

At process 770, a teacher output distribution (e.g., 508a in FIG. 5) is obtained from the teacher model and a student output distribution (e.g., 508b in FIG. 5) from the student model.

At process 780, at least the student model is updated based on a disagreement loss metric computed based on the teacher output distribution as a soft target and the student output distribution. In one implementation, both the student model and the teacher model may be jointly updated based on the disagreement loss metric, e.g., via backpropagation paths 445a-b as shown in FIG. 4D.

### Example Performance

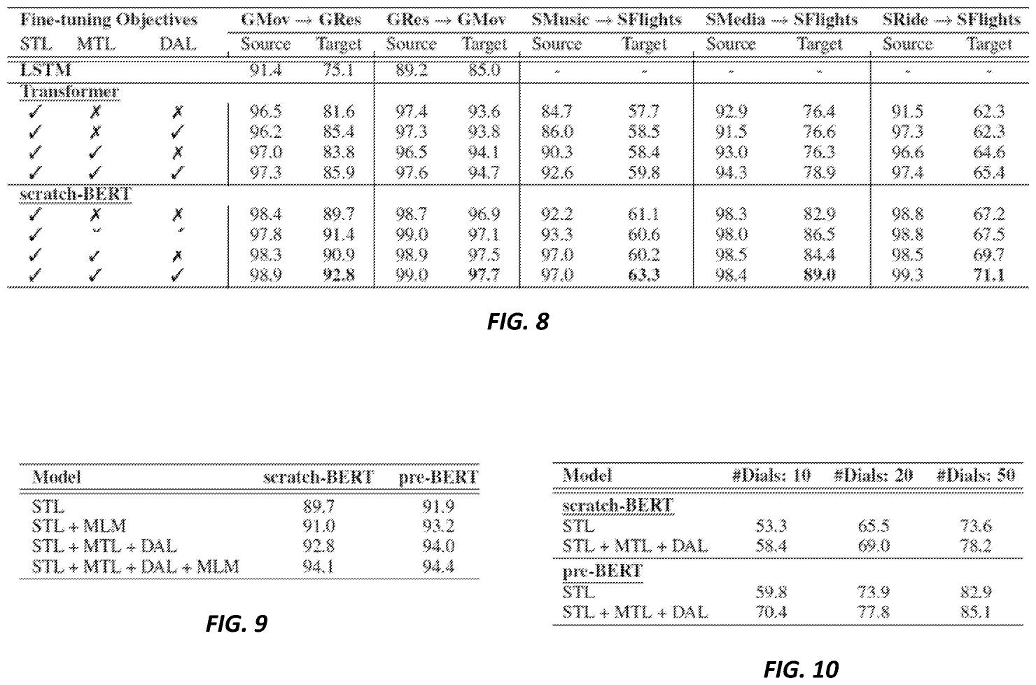

FIGS. 8-13C provide example data charts and data output excerpts illustrating the performance of the mask augmented language model for dialogue act tagging tasks. For example, the input dialogue history 340 may include GSIM (see Shah et al., Building a conversational agent overnight with dialogue self-play, ArXiv, abs/1801.04871, 2018) and SGD (see Rastogi et al.). The GSIM consists of machine-machine task-oriented dialogues in two tasks of two different domains: buying a movie ticket (GMov) and reserving a restaurant table (GRes). It contains 1500/469/1117 dialogues for the train/dev/test sets. The dialogue acts are mapped to 13 tags in universal schema. SGD consists of 22,825 schema-guided single/multi-domain dialogues where domains can have multiple schemas, each defined by a set of tracking slots. Single-domain dialogues of smaller sizes are used as training datasets, including music (SMusic), media (SMedia), ride-sharing (SRide) as source domains to study generalization on flights (SFlights), the largest one, as the target domain.

FIG. 8 provides a data table illustrating example performance of adapting the dialogue act tagger from source domain to a target domain. The data table in FIG. 8 shows the effect of incorporating the proposed MTL and DAL objectives on top of STL (baseline) for language models such as Transformer and BERT models, using Micro-F1 scores on the test set of source and target domains with combinations of STL, MTL, and DAL objectives. The scratch-BERT is initialized from original BERT-base-uncased. Transformer is a randomly initialized version of scratch-BERT. Transformer baseline model on DA tagging with STL objective leads to considerable improvements on the LSTM. Fine-tuning BERT with STL objective from scratch provides further improvements on Transformer, establishing a much stronger baseline both on source and target domain performance. For both Transformer and BERT models, the DAL and MTL objectives are independently useful in further improving the cross-domain generalization over strong baselines that are trained only with STL objective while not hurting the source domain performance. Moreover, fine-tuning on the combined unsupervised objective of DAL and MTL leads to the best performance (last row) on target domains across the board, hinting they provide orthogonal benefits.

FIG. 9 provides an example data table showing the micro-F1 scores on target (GRes) domain for pre-BERT (obtained by domain-adaptive pre-training) in comparison with scratch-BERT (initialized from BERT) across different fine-tuning objectives. Specifically, the effect of MLM is highlighted when used as a fine-tuning objective on unlabeled target domain examples in the second and fourth rows. The domain-adaptive pre-training of BERT model on the combination of source and target domain dialogues with MLM loss before fine-tuning it on the task may be explored. As presented in FIG. 9, pre-BERT helps improve the F1 score on the target domain (GRes) by up to 2.2% over the strong scratch-BERT model across different training objectives. Incorporating mask augmentation into pre-BERT via the DAL and MTL objectives leads to 2.1% boost over fine-tuning with only STL, achieving 4.8% F1 score improvement over LSTM (89.2%) trained on the full labeled data (GRes) itself in a supervised way. This might partly be due to the effect of learning a more domain-aware MASK token, which in return may lead to a more informed and useful teacher representation.

The MLM loss may also be used as unsupervised fine-tuning objective on the target domain dialogues. As shown in FIG. 9, it helps improve the cross-domain generalization performance. Specifically, the ultimate model (last row) achieves 94.1% and 94.4% F1 scores on the target domain for scratch-BERT and pre-BERT models, respectively.

FIG. 10 shows a data table illustrating example F1 scores on target domain (GRes) under the low-resource setting. The “#Dials” denotes the number of labeled dialogues (randomly sampled) used in the source domain (GMov). An average of 3 runs with different samples is evaluated.

As shown in FIG. 10, the benefit of mask augmentation through DAL and MTL objectives becomes larger as the number of labeled dialogues in the source domain gets smaller. The effect of domain-adaptive pre-training also becomes stronger, providing 12% improvement over scratch-BERT when only 10 labeled dialogues are avail-able in the source domain while achieving 85.1% F1 score on the target domain with 50 labeled dialogues when combined with mask augmentation.

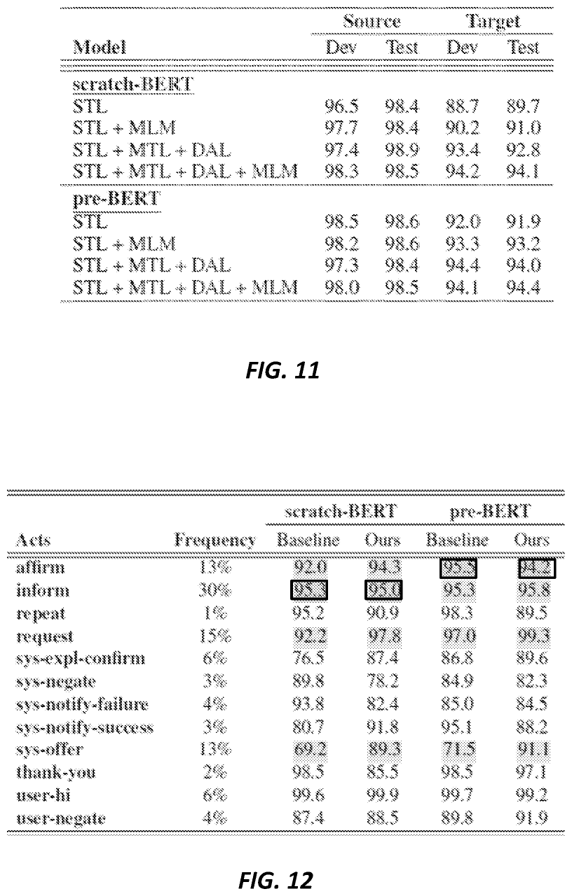

FIG. 11 shows a data table illustrating F1 scores on source (GMov) and target (GRes) domains when MLM objective on unlabeled target domain examples is incorporated into the training. In FIG. 11, the set of complete results (including the performance on development split for both source and target domains) for FIG. 9 is shown.

FIG. 12 shows a data table illustrating micro-F1 scores for each dialog act on the test split of target (GRes) domain. Note that the target data without their labels is used in a totally unsupervised fashion, where only the source (GMov) domain provides label supervision. The baseline (STL) is compared with the training scheme (STL+MTL+DAL) through mask augmentation for both scratch-BERT and pre-BERT settings. Frequency indicates the occurrence ratio of the corresponding dialog act in the test split of the target domain. The rows with more than 10% frequency are highlighted with shades. The shaded entries without bold lining indicate the tags on which our method is superior to baseline, and the shaded entries with bold lining indicate the opposite.

In FIG. 12, additional analysis is included on the adaptation performance across the set of all dialog acts in the schema. The mask augmentation provides significant improvement across most of the dialogue acts including frequent ones such as request and sys-offer while not hurting the performance much (if not improving) on other frequenc acts such as affirm and inform. For scratch-BERT setting, baseline (STL) objective obtains superior performance on less frequent dialogue acts including sys-negate, sys-notify-failure, and thank-you, for which the performance drop is mostly bridged in pre-BERT setting. On the other hand, Pre-BERT provides consistent adaptation improvement over scratch-BERT across all dialog acts except for sys-negate and sys-notify-failure.

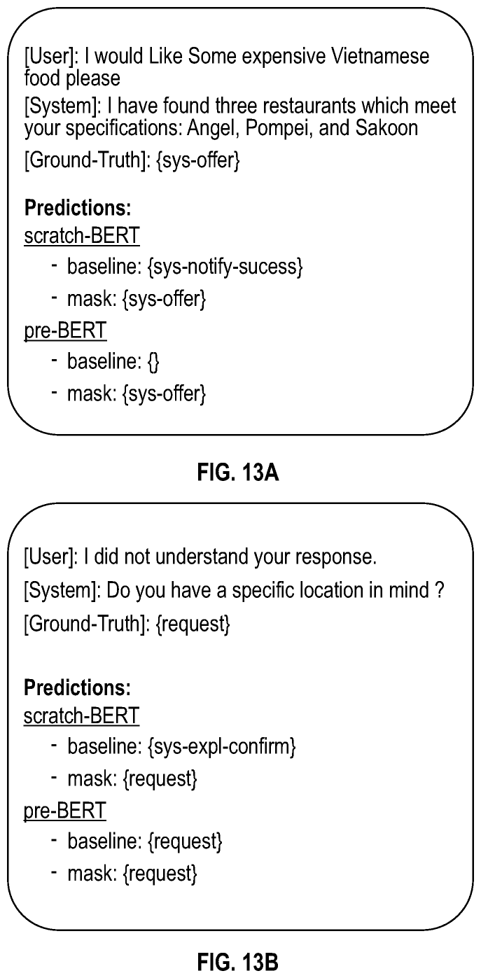

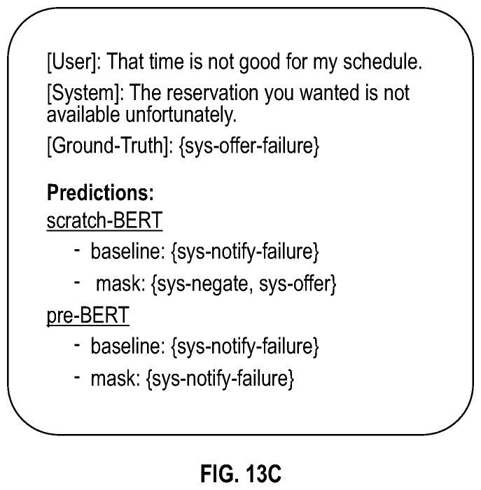

FIGS. 13A-13C provide example data outputs of dialogue act tags from the language model, according to one example of the embodiment described herein. In FIGS. 13A and 13B, examples are shown for improved predictions on sys-offer and request acts. These are some of the most frequent dialogue acts that mask augmentation can provide a significant (5-20%) improvement over the baseline approach for both scratch-BERT and pre-BERT settings. In FIG. 13C, an example is included where scratch-BERT with mask augmentation fails on predicting sys-notify-failure act correctly as opposed the baseline. However, most of such failure cases vanish for pre-BERT setting, where the gap in F1 score drops from 11.4% in scatch-BERT to only 0.5% in pre-BERT as shown in FIG. 12.

Some examples of computing devices, such as computing device 100 may include non-transitory, tangible, machine readable media that include executable code that when run by one or more processors (e.g., processor 110) may cause the one or more processors to perform the processes of method 200. Some common forms of machine readable media that may include the processes of method 200 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A system for dialogue act tagging with pre-trained mask tokens, the system comprising:
an input interface configured to receive an input of dialogue history for training a language model for performing dialogue act tagging;
a memory configured to store a teacher model and a student model corresponding to the language model;
a processor configured to:
generate a first training sequence by masking a first set of tokens from an input sequence obtained from the dialogue history;
generate a second training sequence by masking a second set of tokens from the input sequence;
input the first training sequence to the teacher model and the second training sequence to the student model, respectively;
obtain a teacher output distribution from the teacher model and a student output distribution from the student model; and
update the student model based on a disagreement loss metric computed based on the teacher output distribution as a soft target and the student output distribution.

2. The system of claim 1, wherein the first set of tokens are randomly selected according to a first probability, and the second set of tokens are randomly selected according to a second probability, and wherein the second probability is greater than the first probability.

3. The system of claim 1, wherein the processor is further configured to:
compute a masked language model (MLM) loss using the student output distribution, wherein the language model is pre-trained with a same masked language model objective; and
update the student model based on the masked language model loss.

4. The system of claim 3, wherein the processor is further configured to:
obtain labeled dialogue data from the input of dialogue history; and
generate a third training sequence from the labeled dialogue data;
generate by the language model an output tagging distribution in response to the third training sequence; and
generate a first supervised tagging loss based on the output tagging distribution and annotated labels from the labeled dialogue data.

5. The system of claim 4, wherein the processor is further configured to:
generate a fourth training sequence by randomly replacing a third set of tokens from the third training sequence according to a perturbation probability;
generate a second supervised tagging loss using the fourth training sequence as input to the language model; and
generate a masked tagging loss by taking an expectation of the second supervised tagging loss.

6. The system of claim 5, wherein the processor is further configured to update the language model based on any combination of the disagreement loss metric, the MLM loss, the first supervised tagging loss and the masked tagging loss.

7. The system of claim 1, wherein the processor is further configured to:
generate the input sequence by concatenating a plurality of user utterances and a plurality of system responses from the dialogue history to form a dialogue representation and embedding the dialogue representation with a plurality of pre-defined tokens.

8. The system of claim 1, wherein the language model is pre-trained with labeled dialogue data that belongs to a first domain, and wherein the input of dialogue history contains unlabeled dialogue data that belongs to a second domain.

9. A method for dialogue act tagging with pre-trained mask tokens, the method comprising:
receiving, via a data input interface, an input of dialogue history for training a language model for performing dialogue act tagging;
generating, by a processor, a first training sequence by masking a first set of tokens from an input sequence obtained from the dialogue history;
generating a second training sequence by masking a second set of tokens from the input sequence;
inputting the first training sequence to a teacher model and the second training sequence to a student model, respectively, wherein the teacher model and the student model correspond to a language model;
obtaining a teacher output distribution from the teacher model and a student output distribution from the student model; and
updating the student model based on a disagreement loss metric computed based on the teacher output distribution as a soft target and the student output distribution.

10. The method of claim 9, wherein the first set of tokens are randomly selected according to a first probability, and the second set of tokens are randomly selected according to a second probability, and wherein the second probability is greater than the first probability.

11. The method of claim 9, further comprising:
computing a masked language model (MLM) loss using the student output distribution, wherein the language model is pre-trained with a same masked language model objective; and
updating the student model based on the masked language model loss.

12. The method of claim 11, further comprising:
obtaining labeled dialogue data from the input of dialogue history; and
generating a third training sequence from the labeled dialogue data;
generating by the language model an output tagging distribution in response to the third training sequence; and
generating a first supervised tagging loss based on the output tagging distribution and annotated labels from the labeled dialogue data.

13. The method of claim 12, further comprising:
generating a fourth training sequence by randomly replacing a third set of tokens from the third training sequence according to a perturbation probability;
generating a second supervised tagging loss using the fourth training sequence as input to the language model; and
generating a masked tagging loss by taking an expectation of the second supervised tagging loss.

14. The method of claim 13, further comprising updating the language model based on any combination of the disagreement loss metric, the MLM loss, the first supervised tagging loss and the masked tagging loss.

15. The method of claim 9, further comprising:
generating the input sequence by concatenating a plurality of user utterances and a plurality of system responses from the dialogue history to form a dialogue representation and embedding the dialogue representation with a plurality of pre-defined tokens.

16. The method of claim 9, wherein the language model is pre-trained with labeled dialogue data that belongs to a first domain, and wherein the input of dialogue history contains unlabeled dialogue data that belongs to a second domain.

17. A non-transitory processor-readable storage medium storing processor-executable instructions for dialogue act tagging with pre-trained mask tokens, the instructions being executed by a processor to perform:
receiving, via a data input interface, an input of dialogue history for training a language model for performing dialogue act tagging;
generating, by a processor, a first training sequence by masking a first set of tokens from an input sequence obtained from the dialogue history;
generating a second training sequence by masking a second set of tokens from the input sequence;
inputting the first training sequence to a teacher model and the second training sequence to a student model, respectively, wherein the teacher model and the student model correspond to a language model;
obtaining a teacher output distribution from the teacher model and a student output distribution from the student model; and
updating the student model based on a disagreement loss metric computed based on the teacher output distribution as a soft target and the student output distribution.

18. The medium of claim 17, wherein the first set of tokens are randomly selected according to a first probability, and the second set of tokens are randomly selected according to a second probability, and wherein the second probability is greater than the first probability.

19. The medium of claim 17, wherein the instructions are further executed by the processor to perform:
generating the input sequence by concatenating a plurality of user utterances and a plurality of system responses from the dialogue history to form a dialogue representation and embedding the dialogue representation with a plurality of pre-defined tokens.

20. The medium of claim 17, wherein the language model is pre-trained with labeled dialogue data that belongs to a first domain, and wherein the input of dialogue history contains unlabeled dialogue data that belongs to a second domain.
